(19) United States
(12) Patent Application Publication
(10) Pub. No.: US 2007/0254807 A1
(43) Pub. Date: Nov. 1, 2007

(54) PROCESS FOR THE MANUFACTURE OF CARBONACEOUS MERCURY SORBENT FROM COAL

(75) Inventors: Ramon E. Bisque, Golden, CO (US); George Rouse, Golden, CO (US); Kenneth E. Baldrey, Denver, CO (US); Robin Stewart, Arvada, CO (US)

Correspondence Address: SHERIDAN ROSS PC, 1560 BROADWAY, SUITE 1200, DENVER, CO, 80202, US

(73) Assignee: ADA ENVIRONMENTAL SOLUTIONS, LLC, Littleton, CO (US)

(21) Appl. No.: 11/742,848

(22) Filed: May 1, 2007

Related U.S. Application Data
(60) Provisional application No. 60/796,778, filed on May 1, 2006.
(60) Provisional application No. 60/911,230, filed on Apr. 11, 2007.

(51) Int. Cl. C01B 31/08

(52) U.S. Cl. 502/437

(57) ABSTRACT

The present invention is directed to a process for manufacturing a carbonaceous sorbent, particularly activated carbon, that uses lower average residence times and/or higher operating temperatures to produce activated carbon having favorable properties for mercury collection.

### CROSS REFERENCE TO RELATED APPLICATION

The present application claims the benefits of U.S. Provisional Application Ser. No. 60/796,778, filed May 1, 2006, entitled “ADESORB Process for Economical Production of Sorbents for Mercury Removal from Coal-Fired Power Plants” and Ser. No. 60/911,230, filed Apr. 11, 2007, of the same title, each of which is incorporated herein by this reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. DE-FG02-06ER84591 awarded by the U.S. Department of Energy.

### FIELD OF THE INVENTION

The invention relates generally to sorbents and particularly to carbonaceous mercury sorbents, such as activated carbon.

### BACKGROUND OF THE INVENTION

In 2005, the EPA issued the Clean Air Mercury Rule to permanently cap and reduce mercury emissions from coal-fired power plants. When fully implemented, the rules will reduce utility emissions of mercury from 48 tons a year to 15 tons a year, a reduction of nearly 70 percent. The Clean Air Mercury Rule establishes “standards of performance” that limit mercury emissions from new and existing coal-fired power plants and creates a market-based-cap-and-trade program that will reduce nationwide utility emissions of mercury.

A common method for mercury collection is the injection of powdered carbonaceous sorbents, particularly activated carbon, upstream of either an electrostatic precipitator or a fabric filter baghouse. Activated or active carbon is a porous carbonaceous material having a high adsorptive power. This technology can be used on all coal-fired power plants, even those with wet and dry scrubbers.

Activated carbon is produced from a variety of carbonaceous materials (e.g., coal (lignite), graphite, oil shale, peat, and wood) by carbonization followed either by chemical or physical activation processes. Carbonization or pyrolysis is defined as the progressive carbon enrichment of a material by heating in an inert (substantially oxygen free) atmosphere to remove volatile constituents by decomposition.

Chemical activation processes impregnate the feed material or carbonized product with chemical compounds that provide desired functional groups on the surface of the activated carbon. Exemplary chemical compounds include metallic chloride solution, potassium carbonate, magnesium carbonate, sodium hydroxide, and sodium, potassium, or other sulfates.

In physical activation processes, the carbonaceous material undergoes classification, i.e., the carbon is converted into gas by reaction with an oxidizing gas, such as carbon dioxide, steam, and air. The basic reaction of carbon with carbon dioxide is endothermic and can be expressed stoichiometrically as,

C+CO₂=2CO (1)

### Similarly, the reaction of carbon with water can be expressed as,

C+H₂O═CO+H₂ (2)

Under practical conditions (above 800 degrees Celsius), the water gas shift reaction at equilibrium is:

CO+H₂O═CO₂+H₂ (3)

The above gasification reactions thus show strong product inhibition, with the main differences between the two reactions resulting from the larger dimensions of the carbon dioxide molecule compared with the water molecule. These differences include slower diffusion of carbon dioxide into the porous system of the carbon, restricted accessibility of carbon dioxide towards micropores, and a significantly slower reaction rate for the carbon dioxide reaction.

A number of different kilns and furnaces are used for carbonization/activation. An exemplary furnace is the multiple hearth furnace. The furnace contains several hearth areas. The material to be carbonized/activated is fed to the furnace from a hopper through a valve. Each hearth area is individually heated so that any hearth area can be held at any desired temperature, independent of the others. Each hearth has a rotating rabble arm connected to a drive shaft. The rabble arms sweep the material through openings in each hearth area, enabling the material to be passed progressively down through the furnace. At the bottom, the carbon passes out of the furnace and is collected in a hopper. A series of vents in the upper hearths facilitate the removal of gases and volatiles. These vents lead to a common stack, which carries the volatiles off. A vapor line is provided for each of the hearth areas below the carbonization section. This allows for the introduction of steam into each hearth area, which is supplied from a single source near the bottom of the furnace.

The amount of surface area together with the porosity of carbon are important factors in determining the quality of the activated carbon. During activation, pore volume and surface area invariably increase with increasing burn-off until an optimum is reached at which point further activation results in a decrease in surface area and porosity. This results from micropores (having a diameter of no more than about 2 nm) joining together to form mesopores (having a diameter ranging from about 2 to about 50 nm), which finally join together to form macropores (having a diameter of more than about 50 nm).

Mercury control for U.S. coal-fired power plants will require large amounts of powdered activated carbon. Activated carbon production capacity, however, is limited. Currently, the market for activated carbon in the U.S. is $250 million per year, primarily used for drinking water and beverages. If activated carbon were to be used at all 1,100 U.S. coal fired power plants, the estimated market would be an extra $1 to $2 billion per year, which would require increasing current capacity by a factor of four to eight. A new facility to produce activated carbon would cost approximately $100 million to make enough product for 100 plants and could take four to five years to build. This means that there could be significant increases in price due to the slow response to new demand.

There is a need not only to reduce the cost of activated carbon for mercury removal but also to increase inexpensively activated carbon yield.

### SUMMARY OF THE INVENTION

These and other needs are addressed by the various embodiments and configurations of the present invention. The present invention is directed generally to the production of a carbonaceous mercury sorbent, particularly an activated carbon mercury sorbent.

In one embodiment of the present invention, a method for producing activated carbon includes the steps:

(a) introducing coal into a furnace;

(b) carbonizing and activating the coal in the furnace in the presence of an input gas to produce a carbonaceous sorbent, with a maximum temperature in the furnace being at least about 800 degrees Celsius and/or the average residence time of coal in the furnace being no more than about 180 minutes; and

(c) discharging the carbonaceous sorbent from the furnace.

The carbonaceous sorbent, which is typically activated carbon, preferably has more macroporous and mesoporous surface area than microporous surface area. While not wishing to be bound by any theory, it has been discovered, contrary to the teachings of the prior art, that the higher amount of surface area provided by a higher micropore density equates to a lower, and not higher, degree of mercury removal and can cause problems. Macroporous structure is necessary to facilitate rapid mercury transfer to the inner mesoporous surfaces. However, micropore diameters frequently are smaller than the diameter of a mercury atom. In contrast to mespores, micropores have therefore been found to have limited mercury adsorptivity and can cause problems in downstream processing steps, particularly during particulate collection. Micropores are a cause of surface oxidation, which generates heat. In baghouses, oxidation of conventional collected activated carbon having high micropore concentrations is believed to cause spontaneous combustion in fly ash hoppers, because heat can readily accumulate in the collected particulates due to the thermal insulative properties of the collected particulates. Quantitatively, the activated carbon preferably has a mesoporous surface area of at least about 30% of total surface area To oxidize elemental mercury, the activated carbon preferably comprises about 1000 ppm or more of a halogen.

To provide the higher mesoporous surface area while maximizing product yield, shorter residence times at higher operating temperatures than conventional activated carbon furnaces have been found to be effective. Such conditions have the added benefits of a higher furnace capacity and higher yield than in conventional activated carbon manufacturing processes. In other words, activated carbon production can be increased by 50 to 100% and, for a given size of capital equipment, much higher production rates can be realized and economies of scale gained.

The molecular oxygen in the furnace output is preferably no more than about 1.0 mole % of the outlet total gas composition. The carbonaceous feed is preferably coal. Preferred coal ranks are lignites, sub-bituminous and low-coking bituminous. More preferably, the coal has a high degree of friability, has a low degree of coking, is a low sulfur coal, is a low iron coal, and is an alkaline coal. Low coking coals are preferred to minimize non-exposed gas bubbles in the activated sorbent. Coking properties of a coal can be characterized by the free swelling index. Preferably, the free swelling index is less than about 2 and more preferably less than about 1.

It has further been found that the mercury adsorption capability of the activated carbon is increased by controlling (e.g., reducing) the degree of surface oxidation prior to contact with the mercury-containing waste gas. In one configuration, oxidation is controlled by maintaining, after discharge from the furnace, the activated carbon in an atmosphere having a partial pressure of molecular oxygen of no more than about 0.02 atm until cooled to about 100 degrees Celsius or less or the activated carbon in an inert or reducing atmosphere to inhibit surface oxidation of the activated carbon. In another configuration, an oxidation inhibitor, such as water or a non-oxygenated gas such as nitrogen or carbon dioxide, is contacted with the activated carbon in the final activation chamber or after production and before use, to inhibit surface oxidation.

The present invention can provide a number of advantages depending on the particular configuration. The present invention can provide an activated carbon sorbent tailored for mercury adsorption. Such a sorbent is not only effective in removing speciated and elemental mercury from waste gases but also can be produced much more inexpensively and at a much higher yield than conventional activated carbon sorbents.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 depicts a plant configuration according to an embodiment of the invention;

FIG. 2 depicts a furnace according to an embodiment of the invention;

FIG. 3 depicts a flow chart according to an embodiment of the invention; and

FIG. 4 is a schematic of a sorbent screening device used in various experiments.

### DETAILED DESCRIPTION

The preferred embodiment of the present invention is directed towards the production of a carbonaceous sorbent, particularly activated carbon, having optimal, or near optimal, surface characteristics for absorbing mercury from gases. Current commercial activated carbon production processes produce sorbents with a specific pore size, surface area, and activation properties for use in water treatment applications to remove impurities. Such conventional sorbents typically are subjected to long processing times and high processing temperatures to maximize micropore concentration or density while minimizing mesopore and macropore concentrations or densities.

While not wishing to be bound by any theory, it is believed that conventional sorbents do not possess optimal, or near optimal, properties for airborne mercury removal. Mesopores, and not micropores, are believed to assist in mercury capture. An optimal mercury sorbent therefore should have minimal micropore concentrations or densities and maximal mespore concentrations or densities. Additional desired sorbent features include a reduced level of surface oxidation and a mercury oxidant, such as one or more halogens, present on the sorbent surface. Halogens will oxidize elemental mercury, which oxidized mercury can then be captured by a suitable mechanism, such as entrapment, ionic attraction, or chemisorption, by a mesoporous sorbent. Mesopores can tightly hold oxidized mercury, even under landfill conditions. Preferably, the sorbent has a mesoporous surface area of at least about 30% of total surface area, more preferably of at least about 40%, and even more preferably ranging from about 45% to about 50%. Mesoporous surface area where used herein refers to the Barret, Joyner and Halenda classical method for calculation of pore filling from nitrogen adsorption isotherms. Preferably, the sorbent has a halogen concentration of at least about 1000 ppm, more preferably of at least about 2000 ppm and even more preferably ranging from about 2000 ppm to about 8000 ppm.

It has been discovered that such sorbents can be produced using different process parameters in conventional activated carbon process plant configurations. Carbonization and activation temperatures can be higher, residence times lower, and yield higher than in conventional activated carbon manufacturing processes. These parameters are discussed in detail below.

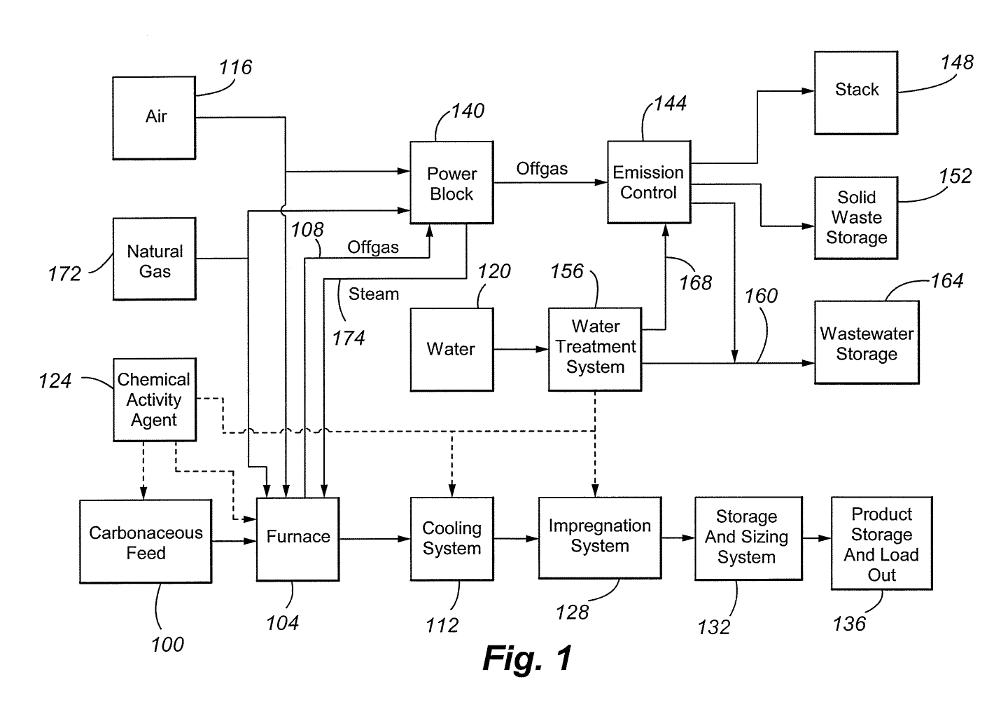

The mercury sorbent manufacturing process will now be described with references to FIGS. 1-3.

The carbonaceous feed 100 is an organic carbonaceous material, with coal being preferred. The feed 100 preferably has coal as the primary component. As used herein, “coal” refers to macromolecular network comprised of groups of polynuclear aromatic rings, to which are attached subordinate rings connected by oxygen, sulfur and aliphatic bridges. Coal comes in various grades or ranks including peat, lignite, sub-bituminous coal and bituminous coal. As used herein, “high sulfur coals” refer to coals having a total sulfur content of at least about 1.5 wt. % (dry basis of the coal) while “low sulfur coals” refer to coals having a total sulfur content of less than about 1.5 wt. % (dry basis of the coal); “high iron coals” refer to coals having a total iron content of at least about 10 wt. % (dry basis of the ash) while “low iron coals” refer to coals having a total iron content of less than about 10 wt. % (dry basis of the ash); and “alkaline coals” refer to coals having at least about 15 wt. % calcium as CaO (dry basis of the ash). Preferably, the feed 100 is a coal having a rank of at least lignite and even more preferably of at least sub-bituminous, a high degree of friability, and a low degree of coking, such as a low sulfur western coal, particularly a coal from the Powder River Basin. More preferably, the coal includes less than about 1.5 wt. % (dry basis of the coal) sulfur, less than about 10 wt. % (dry basis of the ash) iron as Fe₂O₃, at least about 15 wt. % calcium as CaO (dry basis of the ash), and a fuel content of at least about 7000 BTU/lb and even more preferably of at least about 7800 BTU/lb. As will be appreciated, iron and sulfur are typically present in coal in the form of ferrous or ferric carbonites and/or sulfides, such as iron pyrite. Low coking coals are preferred in order to minimize non-exposed gas bubbles and undesirable tar formation in the activated sorbent. Coking properties of a coal can be characterized by the free swelling index. Preferably the free swelling index is less than about 2 and even more preferably less than about 1.

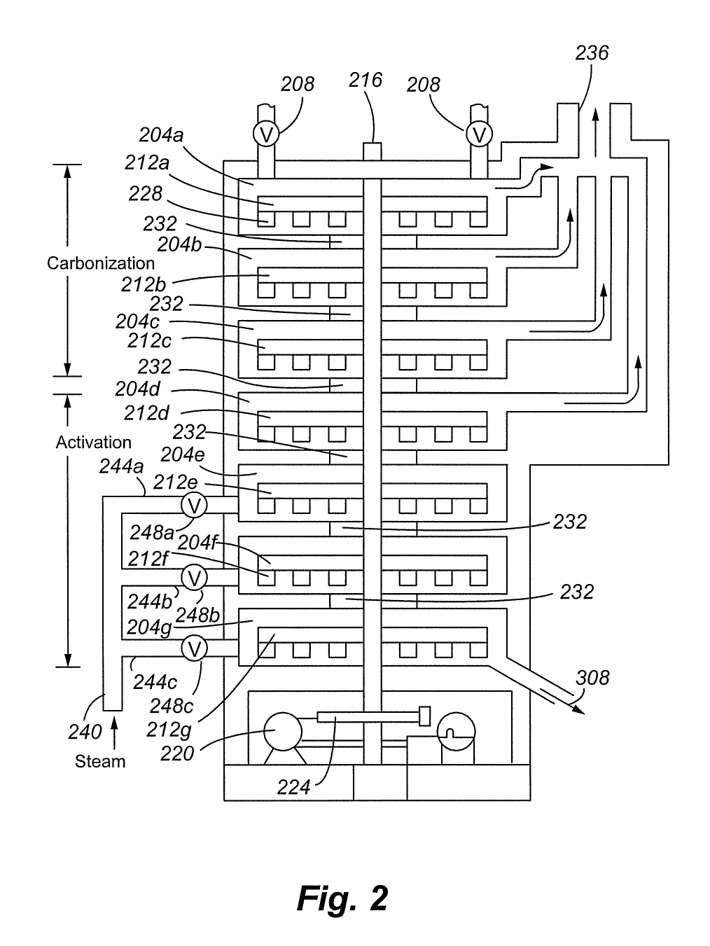

The carbonaceous feed 100 is introduced into a furnace 104 where carbonization (step 300) and activation (step 304) occur. Preferably, the feed 100 has a P₉₀ size of about 2 inches and is not pretreated, such as by briquetting or demineralization prior to introduction into the furnace 104. The temperature of the feed 100 is normally ambient but, to reduce the heat load on the furnace 104, the temperature can be increased using a heat exchanger and the furnace off gas to preheat the feed 100. As shown in FIG. 2, carbonization occurs in a first set of hearth chambers while activation occurs in a second downstream set of hearth chambers. As will be appreciated, carbonization or pyrolysis progressively enriches the carbon content of or chars the carbonaceous feed material and removes moisture and volatile constituents by thermal decomposition. Carbonization typically removes non-carbon elements, with hydrogen and oxygen being among the first elements removed. The freed atoms of elemental carbon are grouped into organized crystallographic formations known as elemental graphitic crystallites. Carbonization is normally performed in an inert (substantially oxygen free) atmosphere, which causes tarry substances and disorganized carbon to deposit in the interstices between the crystallites, resulting in a carbonized product with only a low adsorptive power. In a process known as activation, the carbonized product is contacted with a suitable oxidizing gas to burn out the disorganized carbon and unclog or open the pores between the crystallites and impart surface functional groups onto the char that act as the active sites to remove mercury from waste gases. As will be appreciated, the degree of activation and nature of the feed material 100 determine the final properties of the product.

While carbonization and activation can occur in any suitable type of furnace or kiln, multi-hearth furnaces, such as the furnace 200 of FIG. 2, are preferred. The furnace 200 includes a number of hearth chambers 204a-g. Although only six hearth chambers are shown, it is to be understood that any number of hearth chambers may be employed. The material 100 is normally fed to the furnace 200 from a hopper (not shown) through one or more valves 208. Each hearth chamber is individually heated by separate heating devices (not shown), which enables each hearth chamber to be held at any desired temperature, independent of the other chambers. Each hearth chamber has a corresponding, rotating rabble arm 212a-g, with each rabble arm 212a-g having a plurality of downwardly facing teeth 228. Each rabble arm 212 is connected to a drive shaft 216, which is rotated by a driver 220 and gear assembly 224. As the drive shaft 216 rotates, the rabble arm sweeps the material through openings 232 in each hearth chamber 204, enabling the feed material to be passed progressively down through the furnace 200. At the bottom, the first intermediate product 308 passes out of the furnace 200 and is collected in a hopper (not shown). An interconnected framework of passages 236 in fluid communication with the upper hearth chambers in the carbonization zone facilitate the removal of gases and volatiles. The passages 236 combine to output an offgas 108. A gas injection line 240 is provided for each of the hearth chambers in the activation zone. The line 240 subdivides in to a number of input lines 244a-c, each having a corresponding valve 248a-c and being in fluid communication with a corresponding hearth chamber 204de-g. The line 240 allows for the introduction of a mixture of steam and air into each hearth chamber.

The temperature in each of the carbonization and activation zones and their respective sets of hearth chambers can be important to producing a first intermediate product 308 having desired surface chemistry and properties. Preferably, the hearth chambers in the carbonization zone operate at temperatures of at least about 700 degrees Celsius, more preferably of from about 750 to about 850 degrees Celsius, and even more preferably of from about 750 to about 800 degrees Celsius while those in the activation zone operate at temperatures of at least about 800 degrees Celsius, more preferably of from about 825 to about 950 degrees Celsius, and even more preferably of from about 850 to about 925 degrees Celsius. The chambers in the carbonization zone progressively increase in temperature, with the preferred temperature differential between adjacent chambers ranging from about 10 to about 20 degrees Celsius. A first (upstream) set of chambers in the activation zone also progressively increase in temperature, with the preferred temperature differential between adjacent chambers ranging from about 25 to about 50 degrees Celsius. In contrast, a second (downstream) subset of chambers in the activation zone are at the same or progressively decrease in temperature, with the preferred temperature differential between adjacent chambers being no more than about 10 degrees Celsius. The final chamber before the furnace exit may be cooled by means of steam or other non-oxygen gas such as nitrogen or carbon dioxide to prevent unwanted product burnoff or excessive surface oxidation. The temperature differential between the main activation chamber and the final activation chamber decreases about 50 to about 100 degrees Celsius. The residence time in each of the carbonization and activation zones and their respective sets of hearth chambers also can be important to producing a first intermediate product 308 having desired surface chemistry and properties. Preferably, the average residence time in each hearth chamber is no more than about 15 minutes, more preferably no more than about 12 minutes, and even more preferably ranges from about 10 to about 12 minutes. The total residence time in the furnace 104 preferably is no more than about 180 minutes, more preferably no more than about 150 minutes, and even more preferably ranges from about 135 to about 150 minutes.

The residence time and temperature can produce a relatively high yield. The percentage by weight, or yield, of the first intermediate product 308 relative to the as-received feed 100 preferably is at least about 25%, more preferably is at least about 30%, and even more preferably ranges from about 30 to about 35%.

The composition of the input gas introduced through line 240 into the hearth chambers in the activation zone can also play an important role in the surface chemistry and properties of the first intermediate product 308. In one configuration, the input gas is a mixture of steam 174 and molecular oxygen (air 116). While not wishing to be bound by any theory, it is believed that controlling the oxidation potential of the input gas can impact dramatically the surface properties of the product 308. First, the gas composition is selected so that the atmosphere in the carbonization zone is substantially free of oxidants. Preferably, the molecular oxygen in the atmosphere in the carbonization zone is no more than about 1%, more preferably no more than about 0.9% and even more preferably ranges from about 0.7% to about 0.9% by weight of the gas composition. Second, it is believed that controlling the degree of oxidation of the surface of the first intermediate product 308 in both the carbonization and activation zones can influence positively the ability of the activated carbon product 314 to collect mercury. Finally, the gas preferably contains an inert material, preferably steam 174, to effect activation.

In one configuration, the molecular oxygen in the carbonization and activation chambers is controlled by restricted combustion air flow and evolution of volatile reducing gases in the furnace. The molecular oxygen in the furnace output is preferably no more than about 1.0 mole %, more preferably from about 0.7 to 1.0 mole % and even more preferably ranges from about 0.8 to about 0.9 mole % of the outlet total gas composition. Normally, the inert material is steam 174, and the amount of steam 174 ranges from about 0.5 to about 2.0 lb steam/lb feed 100, more normally from about 0.75 to about 1.51 lb steam/lb feed 100, and even more normally from about 1.0 to about 1.25 lb steam/lb feed 100.

In one configuration, the atmosphere in each of the hearth chambers is reductive due to the presence of one or more gaseous reductants, preferably carbon monoxide. As will be appreciated, molecular oxygen reacts with the carbonaceous feed 100 to form carbon dioxide:

Cₓ+XO₂ [symbol] XCO₂. (4)

An environment would be considered oxidizing whenever the number of moles of molecular oxygen, O₂, available throughout the combustion process exceeds the moles of combustible carbonaceous material, represented by x by a factor of 2.75.

Carbon monoxide may be generated within the furnace by means of a controlled combustion process or supplied as a component of the gaseous mixture supplied to the furnace through a line 240.

The combustion of carbonaceous material, when complete, forms CO₂ (carbon dioxide) as represented by equation 3 or when incomplete, forms CO (carbon monoxide) as represented by equation 5.

2Cₓ+xO₂ [symbol] 2xCO (5)

Since the chemical reactions represented by equations 3 and 5 take place to some extent in all carbonaceous combustion processes, the combustion of a carbonaceous material can be represented by the following chemical equation:

(2−α)Cₓ+xO₂ [symbol] αxCO₂+2x(1−α)CO (6)

where α represents the efficiency of the combustion process. From equation 6 the oxidizing efficiency of can be determined:

$$α = \frac{2 [ {\text{CO}}_{2} ]}{[ \text{CO} ] + 2 [ {\text{CO}}_{2} ]} \qquad ( 7 )$$

where, [CO] and [CO₂] represent a molar measurement, such as the molar concentrations, of carbon monoxide and carbon dioxide, respectively.

To measure the oxidizing efficiency of a converting process, α is determined by measuring the molar concentrations of CO and CO₂ present during the converting process. An oxidizing efficiency can be calculated by equation 7. An atmosphere is considered to be a reducing environment when the calculated oxidizing efficiency, as calculated by α in equation 7, is less than the oxidizing efficiency of an atmosphere operated when a substantial amount of air 116 is introduced into the furnace.

The preferred amount of carbon monoxide can be expressed in many ways. For example, the furnace 104 is preferably operated with a [CO]/[CO₂] ratio of at least about 0.01, which corresponds to an oxidizing environment efficiency of a at least about 0.995. More preferably, the furnace 104 is operated with a [CO]/[CO₂] ratio of at least about 0.1, which corresponds to an oxidizing environment efficiency of α at least about 0.95. Even more preferably, the furnace 104 is operated with a [CO]/[CO₂] ratio of at least about 0.5, which corresponds to an oxidizing environment efficiency of α at least about 0.8. Even more preferably, the furnace 104 is operated with a [CO]/[CO₂] ratio of at least about 1, which corresponds to an oxidizing environment efficiency of α of at least about 0.6. Even more preferably, the furnace 104 is operated with a [CO]/[CO₂] ratio of at least about 5000, which corresponds to an oxidizing environment efficiency of α at least about 0.004.

Reducing atmospheres can be achieved by controlled combustion within the furnace 104 or by controlling the composition of the gas entering the furnace 104 or by a combination thereof. In one embodiment of the invention, the reducing environment is produced by the incomplete combustion of a combustible material.

The first intermediate product 308 preferably has a relatively high fixed carbon content. More preferably, the carbon content of the product 308 ranges from about 50 to about 75 wt. %, more preferably from about 55 to about 75 wt. %, and even more preferably from about 65 to about 75 wt. %. The balance of the product 308 is hydrogen, oxygen, and mineral ash constituents. The bulk density of the product 308 preferably ranges from about 0.4 to about 0.7 gm/cm³, more preferably from about 0.45 to about 0.65 gm/cm³, and even more preferably from about 0.5 to about 0.6 gm/cm³.

The temperature of the first intermediate product 308, when it leaves the furnace 104, is relatively high but the temperature of the final (lowest hearth) is controlled so that any oxygen inleakage from the furnace exit does not result in unwanted burnoff of the final product. Typically, the temperature ranges from about 680 to about 870 degrees Celsius (about 1250 to 1600 degrees Fahrenheit), more typically from about 750 to about 815 degrees Celsius (about 1350 to 1500 degrees Fahrenheit), and even more typically from about 760 to about 790 degrees Celsius (about 1400 to 1450 degrees Fahrenheit).

The product 308, which is in the form a free-flowing particulate, is next cooled (step 312) in a cooling system 112 to a temperature typically of no more than about 260 degrees Celsius (500 degrees Fahrenheit), more typically of no more than about 200 degrees Celsius (400 degrees Fahrenheit), and even more typically of no more than about 150 degrees Celsius (300 degrees Fahrenheit). The cooling system 112 can take many forms. In one configuration, the cooling system 112 includes a heat exchanger that transfers thermal energy, or sensible heat, from the product 308 to another process input stream, such as air 116, feed 100, or water 120.

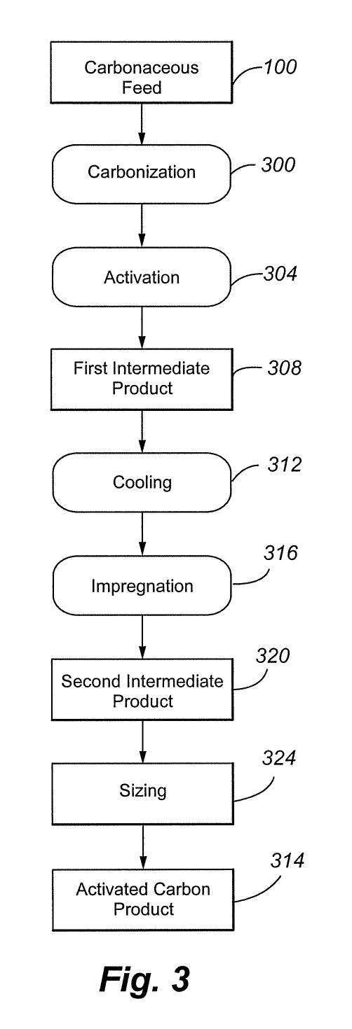

The cooled product is next optionally chemically impregnated or activated in an impregnation system 128 (step 316) using a chemical activating agent 124. Although impregnation is shown as occurring after cooling, it is to be appreciated that it can be performed in other locations. As shown in FIG. 1, the chemical impregnating agent 124 can be added to the carbonaceous feed 100 upstream of or in the furnace 104, the first intermediate product 308 in the cooling system 124 or downstream of the cooling system 112 as shown in FIG. 3.

The chemical activating agent 124 preferably is an oxidant for elemental mercury. Preferred oxidants include halogens and halogenated compounds, with chlorine, chlorinated compounds, bromine, and brominated compounds being particularly preferred. The preferred amount of chemical activating agent 124 on each particle of product 308 preferably is at least about 1000 ppm, more preferably ranging from about 2000 to about 8000 ppm, and even more preferably from about 5000 to about 7000 ppm. The chemical activating agent 124 may be added in the form of a solid, a gas, or a liquid, with the liquid form being a solution or slurry of the agent 124 primarily composed of a volatile carrier.

The second intermediate product 320 is next optionally sized and comminuted in storage and sizing system 132 (step 324) to form the activated carbon product 314. Screens are used to size the product 320 and mills, preferably roller mills, are used to comminute the product 314 to the desired size fraction. Product storage and load out 136 stores and provides either of the products 320 or 314 to rail cars for shipment to the desired destination. In one configuration, the product 320 is free of comminution after discharge from the furnace 104, and the product 320 is later comminuted to the desired size at the end use site, or utility. In this way, oxidation of the surface of the product 320 during subsequent storage and shipment is reduced. This configuration is further discussed in copending U.S. application Ser. No. 10/817,616, filed Apr. 4, 2004, which is incorporated herein by reference.

In one configuration, the degree of oxidation of the surface of the first intermediate product 308 is controlled carefully to optimize the mercury collection ability of the product 308. It is believed that oxygen functional groups on the surface of the activated carbon can interfere with mercury adsorption due to fewer functional sites being available. Oxidation suppression is done in many ways. For example, the product 308, from the time of discharge from the furnace 104 to load out or at least until the product is cooled below about 100 degrees Celsius, is maintained under substantially inert, or reducing, conditions. The rail car carrying the product 308 or 314 is an enclosed railcar or truck, which further controls oxidation of the product during shipment. The partial pressure of molecular oxygen and other oxidants in the atmosphere contacting the particulated product 308 is preferably no more than about 0.10 atm, more preferably no more than about 0.05 atm, and even more preferably no more than about 0.02 atm. The atmosphere can contain an inert gas, such as steam, carbon dioxide, or a noble gas, or a reducing agent, such as carbon monoxide. This has the added advantage of impregnating the pores with a reducing or inert gas, thereby inhibiting the entry of oxidants into the pores during subsequent storage and handling and use.

In another configuration, surface oxidation is inhibited by contacting the activated carbon surface with an oxidation inhibitor that volatilizes at elevated temperatures, such as those encountered in (utility) flue gases. An exemplary oxidation inhibitor is water. When water is used, the activated carbon product 314 typically comprises from about 4 to about 14 wt. % water, more typically about 6 to about 12 wt. % water, and even more typically about 8 to about 10 wt. % water. The water may be sprayed onto the activated carbon during or after cooling (step 312).

Referring to FIG. 1, the product 308 is preferably conveyed mechanically or pneumatically from the furnace 104 to product storage and load out 136. As noted, during pneumatic conveyance the conveying gas preferably has controlled amounts of molecular oxygen.

Referring to FIG. 1, a power block 140 is provided that is conventional. The power block 140 typically includes waste heat recovery boiler(s) to recover heating fuel in the furnace offgas as fuel, after burner(s), blower(s), pump(s), compressor(s), steam turbine generator(s) to generate electrical energy, steam surface condenser(s), heat exchanger(s), and the like.

The offgas 108 from the furnace 104 is subject to emission control 144 prior to being discharged from stack 148. Any suitable technique can be used to remove controlled substances from the offgas 108. In one configuration, the offgas 108, after passing through the after burner and waste heat recovery boiler, is contacted with the activated carbon product 314 in a mercury adsorption system, a spray dryer to remove sulfur dioxide, and an electrostatic precipitator or baghouse to remove the mercury laden activated carbon sorbent. The sorbent is stored in solid waste storage 152.

System water 120 is subjected to water treatment system 156 by known techniques to form wastewater 160, which is passed to wastewater storage 164, and the treated water 168 passed to power block 140 for conversion into steam. In one configuration, the water treatment system 156 includes ultrafilter(s) and an electrocoagulation unit.

Natural gas 172 is used to start the combustion process in the furnace 104.

### Experimental

The current commercial activated carbon production processes were designed to produce sorbents with specific pore size, surface area, and activation properties primarily for use in removing impurities in water-treatment applications. The long processing times produce the desired properties for water treatment, but result in low yields of product. As described below, both laboratory and field testing indicate that regarding mercury control, this long processing time is unnecessary. Reductions in processing time result in less carbon being burned off, much higher yield and subsequent throughput. High temperatures (e.g., 800-950° C.) are in general, favorable because high temperatures result in faster processing of the material. A key cost savings is time, which results in greater throughput and more carbon produced for the same amount of time, capital investment and energy.

Carbonaceous mercury sorbents were produced from a variety of lignite and subbituminous coals. All of the coals were analyzed using ASTM test methods for ultimate, proximate, and minerals. Next, activated carbons were prepared from selected coals. The coals were first sized to −8 mesh (2.38 mm). They were then pyrolized at 700° C. in a dry nitrogen gas stream to evolve the volatile constituents including moisture. Next the samples were physically activated by passing hot steam and nitrogen over the devolatilized char material. The activation tests were performed in a horizontal borosilicate tube inside a clamshell electric heater. The granular sample was weighed and placed in the tube so that the gas would flow over a thin bed of the sample. Hot nitrogen flowed through the bed during the process. When the bed reached the desired temperature, water was pumped into the inlet through a preheated section to create steam before the liquid reached the carbon. When the test was finished, the water was turned off and the sample cooled and weighed. The samples were then ground to 400 mesh (37 micron diameter).

The sample activation time was either 30 or 45 minutes and the temperature was controlled to 800° C. For comparison, this is less than half of the activation time for a conventionally prepared coal-based activated carbon. Samples were cooled under nitrogen flow. They were then ground in a laboratory mill to −325 mesh (44 micron diameter) and sealed for further testing. Sample preparation and handling minimized air exposure.

In our tests, the degree of surface oxidation of the powdered carbonaceous mercury sorbents was found to inversely correlate to mercury removal when the sorbents were exposed to a slipstream flue-gas from a coal-fired boiler. While not wishing to be bound by theory, improved mercury sorption with lower surface oxidation is believed to be due to a relative increase in non-oxygenated surface functional groups that are a necessary intermediate for mercury chemisorption onto the carbon surface via multi-step gas/surface heterogeneous reactions.

Surface oxidation state of the carbonaceous mercury sorbents was measured by an aqueous oxidation-reduction (redox) titration. The procedure involved placing a candidate carbon substrate in a reaction vessel at ambient temperature to be reacted with a measured amount of ceric sulfate oxidant for a fixed time. The solution conditions were adjusted by the addition of a mineral acid. The degree of reaction was then determined by measuring the excess oxidant by titrating with iron. The test results were reported as “surface reducing capacity” in milliequivalents of titrant consumed per gm of sorbent (Meq/gm).

Samples were analyzed for mesoporosity by the standard BJH method from nitrogen adsorption isotherms. The size range covered to the mesopore and small macropore from 20 to 3000 angstroms. Total surface area was determined by the Langmuir method, based on a monolayer coverage of the solid surface by the nitrogen adsorptive.

### Mercury Testing

Mercury slipstream testing was completed at two plants firing subbituminous PRB coals that had mercury CEMs. Plant #1 was a combined flue gas stream from three 90 Mw boilers equipped with hot-side electrostatic precipitators and a downstream baghouse. This unit employs activated carbon injection for mercury control and has a permanent mercury CEM monitoring system. Sample gas was extracted through the mercury CEM probe at a point upstream of the baghouse inlet. Plant #2 was a 630 Mw pulverized coal boiler equipped with a cold-side electrostatic precipitator. This unit employed sulfur trioxide (SO₃) conditioning for particulate control. Vapor SO₃ in flue gas is a known interferrent with carbon mercury sorbents, therefore this represented a more challenging application. The level of SO₃ injection was approximately 5 ppm during the test period. For both Plant #1 and Plant #2 the speciated mercury at the control device inlet (baghouse or ESP) was primarily elemental mercury. The sorbents were not treated with halogens in order to better distinguish inherent performance differences.

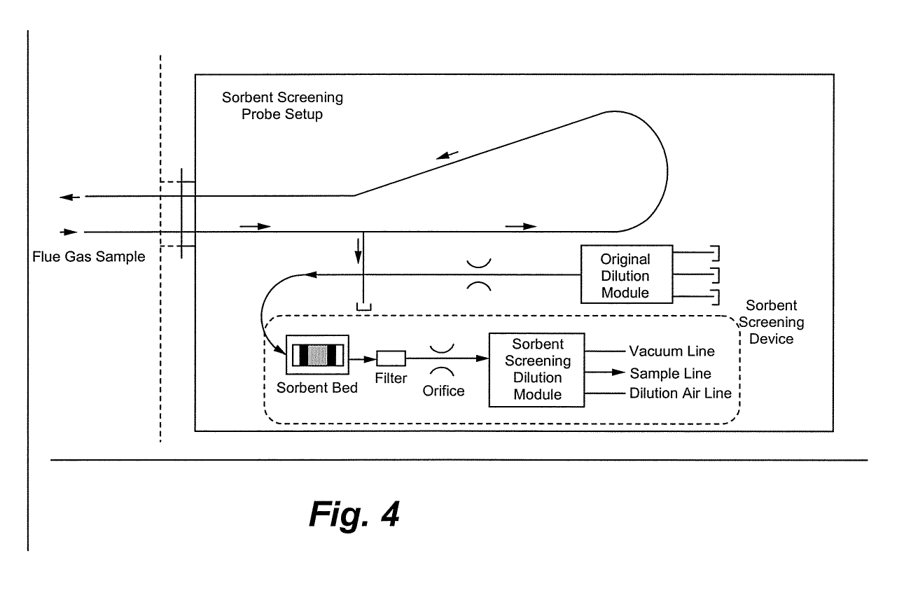

A small amount of the powdered activated carbons was pre-weighed, mixed with sand and fixed into quartz tube test beds. The test beds were loaded with the test material in the laboratory, sealed, and shipped to the test sites. Mercury removal was tested in a slipstream of flue gas extracted through the plant mercury continuous emission monitor (CEM). The prepared test beds were inserted into a sorbent screening device inserted into the CEM sample extraction probe, as shown in FIG. 1. The vapor mercury in the flue gas was extracted from the duct, passed through the test bed, diluted, converted to ionic form (Hg⁺⁺) and transported via heated sample lines. The plant CEM measured the mercury concentration as normal. Sample flow rate and bed sorbent concentration were adjusted to simulate an injection of sorbent into the overall plant flue gas at approximately 5 lbs/mmacf. That rate is representative of mercury control upstream of electrostatic precipitators for plants firing PRB coals. FIG. 4 shows an exemplary sorbent screening device used in the test work.

### Results

Table 1 is a summary of the process and performance data for the six experimentally prepared sorbents and a reference conventional powdered activated carbon, DARCO Hg. The reported mercury removal is an average of removal measured during the first 30 minutes of test bed exposure. This is representative of the relatively short residence time for sorbents injected upstream of an electrostatic precipitator. For this configuration, the sorbent performance is determined by the in-flight mercury capture in the first seconds after injection plus the short-term mercury removal while the sorbent is on the ESP collection plates.

At each plant, a reference commercial powdered activated carbon was prepared in test beds and tested in the identical manner to the experimental sorbents. The reference sorbent was DARCO Hg manufactured by Norit Americas. This is a lignite-based powdered activated carbon that is the most common sorbent for ACI mercury control. None of the experimental sorbents or the reference activated carbon were impregnated with halogens.

TABLE 1
Summary of Results

| | Activation No. | | | | | | |
|---|---|---|---|---|---|---|---|
| | | | | | | | Darco |
| | S45 | S46 | S50 | S47 | S48 | S51 | Hg |
| Coal | Black | Absaloka | Absaloka | Beulah | Oxbow | Oxbow | Texas |
| | Thunder | PRB | PRB | Lignite | Lignite | Lignite | Lignite |
| | PRB | | | | | | |
| Ash (%) | 5.1 | 10.1 | 10.1 | 11.5 | 5.5 | 5.5 | 8–12 |
| Moisture (%) | 25.8 | 22.1 | 22.1 | 25.2 | 34.5 | 34.5 | >30 |
| Fixed Carbon | 37.3 | 36.9 | 36.9 | 33.6 | 31.0 | 31.0 | n/a |
| (%) | | | | | | | |
| Volatiles (%) | 31.8 | 30.9 | 30.9 | 29.7 | 29.0 | 29.0 | n/a |
| Activation | 30 | 30 | 45 | 30 | 30 | 45 | >90 |
| Time | | | | | | | |
| (minutes) | | | | | | | |
| Yield (Char | 33.7 | 36.5 | 21.2 | 36.0 | 27.2 | 21.2 | n/a |
| and | | | | | | | |
| Activation, | | | | | | | |
| %)¹ | | | | | | | |
| Ash in | 15.2 | 27.8 | 25.9 | 32.0 | 15.2 | 15.9 | 30 |
| Sorbent (%) | | | | | | | |
| Surface | 12.4 | 11.5 | 13.7 | 12.7 | 15.2 | 15.9 | 11.0 |
| Reducing | | | | | | | |
| Capacity | | | | | | | |
| (Meq/gm) | | | | | | | |
| Mesopore | 168.6 | 280.9 | 276.5 | 250.4 | 277.1 | 361.6 | n/a |
| Surface Area | | | | | | | |
| (m\hat{ }2/gm) | | | | | | | |
| Total Surface | 581.6 | 558.4 | 558.0 | 600.7 | 657.8 | 720.0 | 600 |
| Area | | | | | | | |
| (m\hat{ }2/gm) | | | | | | | |
| Mesoporous/ | 29.0 | 50.3 | 49.6 | 41.7 | 42.1 | 50.2 | n/a |
| Total Surface | | | | | | | |
| Area (%) | | | | | | | |
| Mercury | 71.6 | 65.0 | 70.9 | 64.8 | 77.2 | 81.5 | 67.0 |
| Removal | | | | | | | |
| Plant #1 (%)² | | | | | | | |
| Mercury | 73.7 | 71.9 | 78.6 | 66.5 | 86.7 | 81.4 | 65.9 |
| Removal | | | | | | | |
| Plant #2 (%)² | | | | | | | |

¹Calculated from as-received basis.
²Average removal of vapor mercury for 30 minutes

### EXAMPLE 1

As an example of the claimed improvements, sample S45 was a 30 minute activation of coal from the Black Thunder PRB mine. This is the largest mine in the Powder River Basin and is representative of the higher rank 8,800 lb/mmbtu southern PRB coals. The sample was steam activated for 30 minutes at 800° C. and gave an overall yield of 33.7%. Compared to the industry standard lignitic PAC, this coal has lower moisture and ash and higher fixed carbon. Ash in the final sorbent was 15.9% compared to 30% for the reference DARCO Hg. Total surface area achieved for S45 was 583 m²/gm, or approximately the same as the reference DARCO Hg carbon. Mercury removal was 71% at Plant 1 and 73% at Plant 2. DARCO Hg mercury removal was 65% and 67% at Plant #1 and Plant #2, respectively. Surface reducing capacity was 12.4 Meq/gm compared to 11.0 for the reference activated carbon. Thus, the experimental carbon achieved significantly higher yield, lower ash, equal surface area, improved mercury performance and a lower surface oxidation. However, the mesoporous surface area was only 28% of the total surface area. Further adjustments in activation time and temperatures could increase the mesoporous surface area for this feedstock.

### EXAMPLE 2

Sample S51 was a Louisiana lignite coal that was steam activated for 45 minutes. Total developed surface area was 720 m²/gm and 362 m²/gm mesoporous surface area. Overall yield was only 21%. Mesoporous surface area was 50% of the total surface area. Surface reducing capacity was 15.9 Meq/gm and mercury removal was 81.5% and 81.4% for Plant #1 and Plant #2, respectively. This was the best performing experimental mercury sorbent. However, the yield was approximately the same as conventional activated carbons produced in multi-hearth furnaces. Because the performance was much higher than an equivalent conventional carbon, the activation could have been optimized for higher yield. Sample S48 is a further example of reduced activation and still superior performance for this same coal. For S48, mesoporous surface area was 42% of total surface area and product yield was 27.2%.

A number of variations and modifications of the invention can be used. It would be possible to provide for some features of the invention without providing others.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for producing activated carbon, comprising:
(a) introducing coal into a furnace;
(b) carbonizing and activating the coal in the furnace in the presence of an input gas to produce a carbonaceous airborne mercury sorbent, wherein a maximum temperature in the furnace is at least about 800 degrees Celsius; and
(c) discharging the carbonaceous airborne mercury sorbent from the furnace,

2. The method of claim 1, wherein the average residence time of coal in the furnace is no more than about 180 minutes and wherein the cumulative mesopore and macropore surface area of the sorbent is more than the micropore surface area.

3. The method of claim 1, wherein, in an output gas from the furnace, molecular oxygen is no more than about 1 mole percent of the total output gas composition, wherein a molar ratio of carbon monoxide to carbon dioxide is at least about 0.01, and wherein α is at least about 0.995.

4. The method of claim 1, wherein the coal comprises coal that is at least one of a lignite, sub-bituminous and bituminous coal, has a high degree of friability, has a low degree of coking with a free swelling index of no more than about 2.0, is a low sulfur coal, is a low iron coal, and is an alkaline coal, wherein the activated carbon has a mesoporous surface area of at least about 40% of total surface area, wherein the sorbent is activated carbon, and wherein the activated carbon comprises at least about 1000 ppm of a halogen.

5. The method of claim 1, further comprising:
(d) after discharge from the furnace, maintaining the sorbent in an atmosphere having a partial pressure of molecular oxygen of no more than about 0.02 atm until cooled to at least 100 degrees Celsius.

6. The method of claim 1, further comprising:
(d) after discharge from the furnace, maintaining the sorbent in at least one of an inert and reducing atmosphere to inhibit surface oxidation of the sorbent.

7. A carbonaceous airborne mercury sorbent manufactured by the process of claim 1.

8. A method for producing activated carbon, comprising:
(a) introducing coal into a furnace;
(b) carbonizing and activating the coal in the furnace in the presence of an input gas to produce a carbonaceous airborne mercury sorbent, wherein an average residence time of the coal in the furnace is no more than about 180 minutes; and
(c) discharging the carbonaceous airborne mercury sorbent from the furnace, wherein the carbonaceous airborne mercury sorbent has at least about 30% mesoporous surface area.

9. The method of claim 8, wherein a maximum temperature in the furnace is at least about 800 degrees Celsius.

10. The method of claim 8, wherein the molecular oxygen in a furnace output gas is no more than about 1.0 mole % of the outlet total gas composition

11. The method of claim 8, wherein the coal comprises coal that is at least one of a lignite, sub-bituminous and low coking bituminous coal, has a high degree of friability, has a low degree of coking, is a low sulfur coal, is a low iron coal, and is an alkaline coal, wherein the sorbent is activated carbon, wherein the activated carbon has a mesoporous surface area of at least about 30% of total surface area, and wherein the activated carbon comprises at least about 1000 ppm of a halogen.

12. The method of claim 8, further comprising:
(d) after discharge from the furnace, maintaining the sorbent in an atmosphere having a partial pressure of molecular oxygen of no more than about 0.02 atm until cooled to at least 100 degrees Celsius.

13. The method of claim 8, further comprising:
(d) after discharge from the furnace, maintaining the sorbent in at least one of an inert and reducing atmosphere to inhibit surface oxidation of the sorbent.

14. A carbonaceous airborne mercury sorbent manufactured by the process of claim 8.

15. An activated carbon product, comprising:
at least about 50 wt. % carbon;
at least about 30% mesoporous surface area; and
at least about 1000 ppm of a halogen and/or halogenated compound.

16. A method, comprising:
(a) in carbonizing and activating zones, converting coal into a carbonaceous sorbent; and
(b) to control oxidation of the carbonaceous sorbent, performing at least one of the following steps:
(B1) after discharge from the carbonizing and activating zones, maintaining the carbonaceous sorbent in at least one of a reducing and inert atmosphere prior to and/or during shipment of the carbonaceous sorbent to a purchaser; and
(B2) after discharge from the carbonizing and activating zones, contacting the carbonaceous sorbent with an oxidation inhibitor prior to and/or during shipment of the carbonaceous sorbent to a purchaser.

17. The method of claim 16, wherein step (B1) is performed and wherein the at least one of a reducing and inert atmosphere has a partial pressure of molecular oxygen of no more than about 0.02 atm until cooled to at least 100 degrees Celsius.

18. The method of claim 16, wherein step (B2) is performed.

19. The method of claim 18, wherein the oxidation inhibitor is water and wherein, after step (B2), the oxidation inhibitor comprises at least about 4 wt. % water.

20. The method of claim 16, wherein, in the carbonizing and activating zones, an average residence time of the coal is no more than about 180 minutes and wherein a maximum temperature in the furnace is at least about 800 degrees Celsius.

21. The method of claim 20, where the molecular oxygen in the furnace output is no more than about 1.0 mole % of the outlet total gas composition.

22. The method of claim 20, wherein the coal comprises coal that is at least one of a sub-bituminous and bituminous coal, has a high degree of friability, has a low degree of coking, is a low sulfur coal, is a low iron coal, and is an alkaline coal, wherein the sorbent is activated carbon, wherein the activated carbon has a mesoporous surface area of at least about 30% of total surface area and wherein the activated carbon comprises at least about 1000 ppm of a halogen.

23. A carbonaceous sorbent manufactured by the process of claim 16.
